(19) United States
(12) Patent Application Publication
(10) Pub. No.: US 2021/0357760 A1
(43) Pub. Date: Nov. 18, 2021

(54) Distributed Deep Learning System and Data Transfer Method

(71) Applicant: Nippon Telegraph and Telephone Corporation, Tokyo (JP)

(72) Inventors: Kenji Tanaka, Tokyo (JP); Yuki Arikawa, Tokyo (JP); Kenji Kawai, Tokyo (JP); Junichi Kato, Tokyo (JP); Tsuyoshi Ito, Tokyo (JP); Huycu Ngo, Tokyo (JP); Takeshi Sakamoto, Tokyo (JP)

(21) Appl. No.: 17/291,082

(22) PCT Filed: Oct. 25, 2019
(86) PCT No.: PCT/JP2019/042008

§ 371 Date: May 4, 2021

(30) Foreign Application Priority Data
Nov. 9, 2018 (JP) 2018-211345

(51) Int. Cl. G06N 3/08; G06N 3/10

(52) U.S. Cl. CPC G06N 3/084; G06N 3/10

(57) ABSTRACT

A distributed deep learning system includes a plurality of computers connected to each other over a communication network, wherein each iteratively performs forward propagation calculation and backpropagation calculation based on learning data, and sends a calculation result of the backpropagation calculation to the communication network, and an Allreduce processing apparatus connected to the computers over the communication network, that processes the calculation results received from the plurality of computers, and returns the calculation results to transmission sources, wherein the computers each include a forward propagation calculator, a backpropagation calculator, a transfer processor that stores the calculation result of the backpropagation calculation in a transfer buffer each time the backpropagation calculator calculates the calculation result of the backpropagation calculation for each of layers, and a communicator that sequentially transmits the calculation results of the backpropagation calculation stored in the transfer buffer to the Allreduce processing apparatus over the communication network.

This patent application is a national phase filing under section 371 of PCT/JP2019/042008, filed Oct. 25, 2019, which claims the priority of Japanese patent application no. 2018-211345, filed Nov. 9, 2018, each of which is incorporated herein by reference in its entirety.

### TECHNICAL FIELD

The present invention relates to a distributed deep learning system and a data transfer method and particularly relates to a technology of transferring data in distributed deep learning using a plurality of computers that cooperate with each other in a network.

### BACKGROUND

Deep learning that causes a multilayered neural network to learn characteristics of data has been proposed. In deep learning, the accuracy of classification and prediction improves by performing learning with use of a larger amount of data for learning. In order to improve the efficiency of the learning processing, a data-parallel-type distributed deep learning system in which a plurality of computers are cooperated with each other in a network and the computers learn different data has been proposed.

As illustrated in FIG. 20, in deep learning in a related-art distributed deep learning system, in a plurality of computers forming the distributed deep learning system, learning data is propagated in order from an input layer to an output layer, and a loss function serving as an index of how much an output value from a neural network deviates from the correct answer (referred to as “label data”) is obtained. The processing of calculating the output value in order from the layer on the input side of the neural network to the layer on the output side thereof as described above is called “forward propagation calculation”.

In the related-art distributed deep learning system, a partial differential value (gradient) in accordance with configuration parameters (weights of the neural network and the like) of the neural network for the loss function value obtained by the forward propagation calculation in each of the computers is obtained. The processing is called “backpropagation calculation” because the gradient for the configuration parameter of each layer is calculated in order from the layer on the output side of the neural network toward the layer on the input side thereof. In deep learning, highly-accurate classification is realized by iteratively performing the forward propagation calculation and the backpropagation calculation.

For example, in a distributed deep learning system disclosed in NPL 1, group communication (hereinafter referred to as “Allreduce processing”) that shares and reduces gradient information among computers is further performed after the backpropagation calculation. In the technology disclosed in NPL 1, the plurality of computers are synchronized with each other, and hence are in any of the states of the forward propagation calculation, the backpropagation calculation, or the Allreduce processing.

In more detail, as illustrated in FIG. 21, in the distributed deep learning system disclosed in NPL 1, the plurality of computers connected to each other over a network perform forward propagation calculation and backpropagation calculation for learning data and calculate the gradients of the layers in the computers. After the gradients of all of the layers are calculated, Allreduce processing for sharing the gradient information among the computers starts.

FIG. 22 illustrates one example of data flow in the related-art distributed deep learning system (see NPL 1). As illustrated in FIG. 22, the gradient information generated by the backpropagation calculation in a graphics processing unit (GPU) included in each of the computers is transferred to a central processing unit (CPU) memory (main memory) from a GPU memory. Then, the gradient information is transferred to a transmit buffer of a network interface card (NIC) and is shared and reduced among the computers by the Allreduce processing.

In order to execute the Allreduce processing in the distributed deep learning system, communication needs to be performed between different computers. Therefore, the result of the backpropagation calculation needs to be transferred to the NIC as described above.

Data returned to each of the computers after the Allreduce processing is stored in a receive buffer of the NIC and is transferred to the CPU memory and the GPU memory in the stated order. In deep learning, each of the computers performs forward propagation calculation with use of the data that is returned after the Allreduce processing, and then calculates the backpropagation again with use of the result of the forward propagation calculation.

In the plurality of computers forming the related-art distributed deep learning system, data transfer between the GPU and the CPU memory that is the main memory and data transfer between the NIC and the CPU memory are performed when the CPU executes orders. The data transfer is performed via a buffer that is a memory area provided for exchanging data. In the related art, the number of buffers provided in each of the GPU, the CPU, and the NIC included in each of the computers is one, and the sizes thereof are also fixed.

### CITATION LIST

### Non Patent Literature

[NPL 1] Tal Ben-Nun and Torsten Hoefler, Demystifying Parallel and Distributed Deep Learning: An In-Depth Concurrency Analysis, arXiv: 1802.09941, 2018, internet <https://arxiv.org/abs/1802.09941>.

### SUMMARY

### Technical Problem

However, in the data transfer technology in the related-art distributed deep learning system, the forward propagation calculation and the backpropagation calculation of the learning data are performed in different periods of time and the Allreduce processing starts after the gradient information of all of the layers is calculated, and hence the waiting time between the backpropagation calculation and the forward propagation calculation has been a bottleneck and a factor of hindering the acceleration of the distributed deep learning processing.

Embodiments of the present invention have been made in order to solve the abovementioned problem, and an object thereof is to provide a data transfer technology capable of performing distributed deep learning processing at a higher speed.

### Means for Solving the Problem

In order to solve the abovementioned problem, a distributed deep learning system according to embodiments of the present invention includes: a plurality of computers which are connected to each other over a communication network, which each iteratively perform forward propagation calculation and backpropagation calculation based on learning data, and which each send a calculation result of the backpropagation calculation to the communication network; and a group communication unit that is connected to the plurality of computers over the communication network, processes the calculation results received from the plurality of computers, and returns the calculation results to transmission sources. In the distributed deep learning system, the computers each include: a calculation unit including: a forward propagation calculation unit that performs the forward propagation calculation for each of layers; and a backpropagation calculation unit that calculates a partial derivative of a configuration parameter of a neural network with respect to an error between a calculation result of the forward propagation calculation and a set label data for each of the layers in an order of an output layer, a middle layer, and an input layer of the neural network; a transfer processing unit that stores the calculation result of the backpropagation calculation in a transfer buffer each time the backpropagation calculation unit calculates the calculation result of the backpropagation calculation for each of the layers; and a communication unit that sequentially transmits the calculation results of the backpropagation calculation stored in the transfer buffer to the group communication unit over the communication network, and the group communication unit processes the calculation results of the backpropagation calculation in an order of reception from the plurality of computers and sequentially outputs the calculation results.

In the distributed deep learning system according to embodiments of the present invention, the communication unit may receive the calculation result of the backpropagation calculation for each of the layers that is processed and returned by the group communication unit over the communication network, and the forward propagation calculation unit may use the calculation result of the backpropagation calculation for each of the layers that is processed and returned by the group communication unit as the input data.

In the distributed deep learning system according to embodiments of the present invention, an adjustment unit that performs adjustment such that the calculation results of the backpropagation calculation for the layers that are processed and returned by the group communication unit and included in the input data input to the forward propagation calculation unit are in an order of an input layer, a middle layer, and an output layer in each of the plurality of computers may be further included.

In order to solve the abovementioned problem, a distributed deep learning system according to embodiments of the present invention includes at least one computer connected over a communication network. In the distributed deep learning system, the computer includes: a communication unit that receives data from outside over the communication network; a first transfer instruction unit that gives an instruction for transferring the received data that is received by the communication unit; a storage unit that stores the received data in a transfer buffer based on the instruction of the first transfer instruction unit; a second transfer instruction unit that gives an instruction for transferring the received data stored in the transfer buffer; and a calculation unit that performs operation of a neural network with use of the received data, wherein the first transfer instruction unit and the second transfer instruction unit asynchronously give instructions, and the second transfer instruction unit gives an instruction for transferring the received data to the calculation unit.

In the distributed deep learning system according to embodiments of the present invention, the second transfer instruction unit may give an instruction for transferring an operation result obtained by the calculation unit to the transfer buffer, the first transfer instruction unit may give an instruction for transferring the operation result to the communication unit from the transfer buffer, and the communication unit may transmit the operation result transferred based on the instruction from the first transfer instruction unit to the outside over the communication network.

In the distributed deep learning system according to embodiments of the present invention, the storage unit may include a plurality of transfer buffers.

In the distributed deep learning system according to embodiments of the present invention, the transfer buffer may be formed so as to have a buffer size that is variable in accordance with a size of data to be stored therein.

In order to solve the abovementioned problem, a data transfer method according to embodiments of the present invention includes: a plurality of computers which are connected to each other over a communication network, which each iteratively perform forward propagation calculation and backpropagation calculation based on learning data, and which each send a calculation result of the backpropagation calculation to the communication network; and a group communication unit that is connected to the plurality of computers over the communication network, processes the calculation results received from the plurality of computers, and returns the calculation results to transmission sources, and further includes: a first step of performing the forward propagation calculation for each of an input layer, a middle layer, and an output layer of a neural network for each of the layers based on input data including the learning data in each of the plurality of computers; a second step of calculating a partial derivative of a configuration parameter of the neural network with respect to an error between a calculation result of the forward propagation calculation and a set label data for each of the layers in an order of the output layer, the middle layer, and the input layer in each of the plurality of computers; a third step of storing the calculation result of the backpropagation calculation to a transfer buffer each time the calculation result of the backpropagation calculation is calculated for each of the layers in the second step in each of the plurality of computers; a fourth step of sequentially transmitting the calculation results of the backpropagation calculation stored in the transfer buffer to the group communication unit over the communication network in each of the plurality of computers; and a fifth step of processing the calculation results of the backpropagation calculation received by the group communication unit in an order of reception from the plurality of computers and sequentially outputting the calculation results.

### Effects of Embodiments of the Invention

According to embodiments of the present invention, the calculation result of the backpropagation calculation is stored in the transfer buffer each time the calculation result of the backpropagation calculation is calculated for each of the layers, the calculation results are sequentially transmitted to the group communication unit, and the execution of the Allreduce processing is performed in parallel with the backpropagation calculation, and hence the distributed deep learning processing can be performed at a higher speed.

### BRIEF DESCRIPTION OF THE DRAWINGS

FIG. 1 is a block diagram illustrating the configuration of a distributed deep learning system according to Embodiment 1 of the present invention.

FIG. 2 is a block diagram illustrating a hardware configuration of a computer according to Embodiment 1.

FIG. 3 is a diagram for describing a data flow of data transfer according to Embodiment 1.

FIG. 4 is a diagram for describing a flow of a data transfer method according to Embodiment 1.

FIG. 5 is a diagram for describing a flow of a data transfer method according to Modified Example 1 of Embodiment 1.

FIG. 6 is a diagram for describing a flow of a data transfer method according to Modified Example 2 of Embodiment 1.

FIG. 7 is a block diagram illustrating the configuration of a distributed deep learning system according to Embodiment 2 of the present invention.

FIG. 8 is a flowchart describing the operation of the distributed deep learning system according to Embodiment 2.

FIG. 9 is a flowchart for describing adjustment processing according to Embodiment 2.

FIG. 10 is a flowchart for describing the adjustment processing according to Embodiment 2.

FIG. 11 is a block diagram illustrating the configuration of a distributed deep learning system according to a modified example of Embodiment 2.

FIG. 12 is a block diagram illustrating the configuration of a distributed deep learning system according to Embodiment 3 of the present invention.

FIG. 13 is a block diagram illustrating a hardware configuration of a computer according to Embodiment 3.

FIG. 14 is a sequence diagram for describing the operation of the distributed deep learning system according to Embodiment 3.

FIG. 15 is a sequence diagram for describing the operation of the distributed deep learning system according to Embodiment 3.

FIG. 16 is a sequence diagram for describing the operation of a related-art distributed deep learning system.

FIG. 17 is a block diagram illustrating a hardware configuration of a computer according to Embodiment 4 of the present invention.

FIG. 18 is a sequence diagram for describing the operation of a distributed deep learning system according to Embodiment 4.

FIG. 19 is a sequence diagram for describing the operation of the related-art distributed deep learning system.

FIG. 20 is a diagram for describing a related-art deep learning processing.

FIG. 21 is a diagram illustrating the configuration example of the related-art distributed deep learning system.

FIG. 22 is a diagram for describing a data flow of related-art data transfer.

### DETAILED DESCRIPTION OF ILLUSTRATIVE EMBODIMENTS

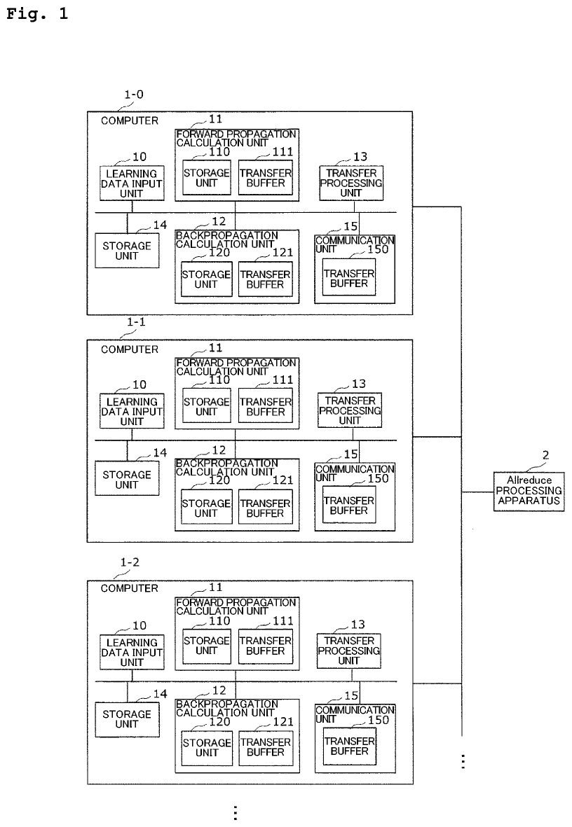

Preferred embodiments of the present invention are described in detail below with reference to FIG. 1 to FIG. 19.

### Embodiment 1

FIG. 1 is a block diagram illustrating the configuration of a distributed deep learning system according to Embodiment 1 of the present invention. The distributed deep learning system according to this embodiment includes a plurality of computers 1-0 to 1-2 that are connected to each other over a communication network and iteratively perform forward propagation calculation and backpropagation calculation, and an Allreduce processing apparatus 2 (group communication unit) connected to the plurality of computers 1-0 to 1-2 over the communication network. The distributed deep learning system performs distributed deep learning by transferring data in the computers 1-0 to 1-2 connected to each other over the communication network and between the computers 1-0 to 1-2 and the Allreduce processing apparatus 2.

In this embodiment, the computers 1-0 to 1-2 may be collectively referred to as computers 1.

Each of the computers 1 includes a learning data input unit 10, a forward propagation calculation unit 11, a backpropagation calculation unit 12, a transfer processing unit 13, a storage unit 14, and a communication unit 15. The forward propagation calculation unit 11 and the backpropagation calculation unit 12 form a calculation unit included in each of the computers 1 according to embodiments of the present invention.

The learning data input unit 10 inputs learning data of a neural network acquired from the outside. The learning data is input to the forward propagation calculation unit 11.

The forward propagation calculation unit 11 includes a storage unit 110 and a transfer buffer 111. The forward propagation calculation unit 11 performs the forward propagation calculation of the neural network on the basis of input data including the learning data. In more detail, the forward propagation calculation unit 11 performs a multiply-add operation of the learning data and weight parameters of the neural network in the order of an input layer, a middle layer, and an output layer forming the neural network. The forward propagation calculation unit 11 outputs the result of the multiply-add operation calculated in a forward propagation direction from the input layer to the output layer. The weight parameters corresponding to nodes of the layers are provided from the outside as initial values, and the weight parameters are adjusted and updated by repeating the forward propagation calculation and the backpropagation calculation in each of the computers 1 and are eventually specified.

The storage unit 110 stores therein the result of the forward propagation calculation executed by the forward propagation calculation unit 11.

The transfer buffer 111 receives the calculation result of the backpropagation calculation on which Allreduce processing has been performed by the Allreduce processing apparatus 2 described below via the communication unit 15 and temporarily stores the calculation result therein.

The backpropagation calculation unit 12 includes a storage unit 120 and a transfer buffer 121. The backpropagation calculation unit 12 calculates a partial derivative of the configuration parameters of the neural network with respect to the error between the calculation result of the forward propagation calculation and the correct answer label (label data) of the learning data for each layer in the order of the output layer, the middle layer, and the input layer. In more detail, the backpropagation calculation unit 12 defines a loss function L serving as an index of how much the calculation result of the forward propagation calculation unit 11 deviates from the correct answer label of the learning data. The backpropagation calculation unit 12 obtains a vector (referred to as a gradient) of which a component is the partial differential value in accordance with each configuration parameter of the neural network for the loss function L for each layer.

The backpropagation calculation unit 12 sequentially outputs the gradient of each layer by performing the backpropagation calculation in the order of the output layer, the middle layer, and the input layer.

The storage unit 120 stores therein the value of the gradient of each layer calculated by the backpropagation calculation unit 12.

The transfer buffer 121 temporarily stores therein the calculation result of the backpropagation calculation to be transmitted to the Allreduce processing apparatus 2 described below. The transfer buffer 121 stores therein the gradient for each layer each time the backpropagation calculation unit 12 calculates the gradients in the order of the output layer, the middle layer, and the input layer. The calculation result of the backpropagation calculation stored in the transfer buffer 121 is transferred to the storage unit 14 that is the main memory of each of the computers 1 from the transfer buffer 121 and is stored therein.

The transfer processing unit 13 stores the gradient for each layer stored in the storage unit 14 that is the main memory to the transfer buffer 150 of the communication unit 15 each time the backpropagation calculation unit 12 calculates the gradient for each layer. The transfer processing unit 13 transfers the calculation result of the backpropagation calculation for each layer processed by and returned from the Allreduce processing apparatus 2 to the forward propagation calculation unit 11 via the communication unit 15.

In more detail, when the gradients of the layers that are the backpropagation calculation results are sequentially stored in the storage unit 14, the transfer processing unit 13 instructs the communication unit 15 to sequentially transmit the gradients to the Allreduce processing apparatus 2. When the communication unit 15 receives the gradients of the layers shared among the computers 1 from the Allreduce processing apparatus 2, the transfer processing unit 13 instructs the storage unit 14 to sequentially store the gradients therein.

The storage unit 14 is the main memory of each of the computers 1. The storage unit 14 stores therein the calculation results obtained by the backpropagation calculation unit 12. The storage unit 14 stores therein the gradient information for each layer processed by and returned from the Allreduce processing apparatus 2. In more detail, the gradient information on which the Allreduce processing has been performed that is stored in the storage unit 14 is data from the Allreduce processing apparatus 2 received by the communication unit 15 and transferred from the communication unit 15 in accordance with the instruction of the transfer processing unit 13.

The storage unit 14 has an area that stores therein the gradient of each layer calculated by the backpropagation calculation unit 12. The storage unit 14 has an area that stores therein the gradient information returned from the Allreduce processing apparatus 2.

The communication unit 15 includes a transfer buffer 150 and is an interface that exchanges data with the Allreduce processing apparatus 2 connected to each of the computers 1 over the communication network. Each of the computers 1 can exchange data with another computer via the communication unit 15.

The communication unit 15 transfers the gradient information returned from the Allreduce processing apparatus 2 to the storage unit 14 on the basis of the instruction from the transfer processing unit 13. In more detail, the communication unit 15 temporarily stores the received gradient information in the transfer buffer 150 and transfers the gradient information to a predetermined area in the storage unit 14 in accordance with the instruction of the transfer processing unit 13.

The communication unit 15 sequentially acquires the gradients of the layers calculated by the backpropagation calculation unit 12 and stored in the storage unit 14 on the basis of the instruction of the transfer processing unit 13 and temporarily stores the gradients in the transfer buffer 150, and then sequentially transmits the gradients to the Allreduce processing apparatus 2.

The Allreduce processing apparatus 2 is formed by an apparatus having an arithmetic function similar to those of the abovementioned computers 1, for example. The Allreduce processing apparatus 2 performs Allreduce processing of receiving the gradients for the layers calculated by the backpropagation calculation units 12 of the computers 1-0 to 1-2, reducing the gradients for each layer in the order of reception, and sharing the gradients between the computers 1-0 to 1-2. For example, the Allreduce processing apparatus 2 receives the gradients of the output layers from the computers 1-0 to 1-2, reduces the gradients for the entirety of the output layers, and returns the reduced gradients of the output layers to the computers 1-0 to 1-2. Similarly, the Allreduce processing apparatus 2 performs the Allreduce processing for each layer also for the middle layer and the input layer.

The Allreduce processing apparatus 2 may calculate an average of the gradients for the layers and return the average to the computers 1-0 to 1-2, for example, in the reduction of the gradients of the layers. As another example, the Allreduce processing apparatus 2 may calculate a sum of the gradients instead of the average of the gradients. For example, when a learn rate η is multiplied by (1/the number of computers) at the time of update processing of the next weight parameter, the same result as an average value of the gradients is obtained. Instead of the average of the gradients, a weighted average may be used by multiplying the gradients by weighting factors, or a sum of squares of each gradient may be used.

The Allreduce processing apparatus 2 may perform the Allreduce processing on the result of the backpropagation calculation for each layer, specify the update expression of the configuration parameters for each layer of the neural network including the weight parameter, and return the update expression to each of the computers 1. The configuration parameters of each layer of the neural network are updated such that the loss function L decreases by the update expression. For example, the update expression may be specified with use of gradient descent.

In this embodiment, an example of a configuration in which three computers 1-0 to 1-2 are connected to each other over the communication network is shown, but the number of the computers 1 is not limited thereto. The Allreduce processing apparatus 2 is described with an example in which the Allreduce processing apparatus 2 is provided as an apparatus independent of the computers 1, but the function of the Allreduce processing apparatus 2 may be provided in one of the plurality of computers 1 connected to each other over the communication network.

### Hardware Configuration of Computer

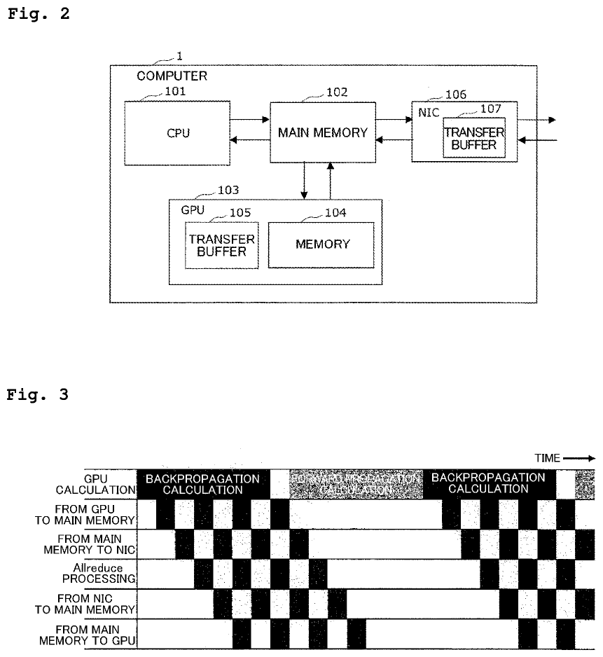

Next, a hardware configuration of each of the computers 1 described above is described with reference to FIG. 2.

As illustrated in FIG. 2, each of the computers 1 includes a central processing unit (CPU) 101, a main memory 102, a graphics processing unit (GPU) 103, and a network interface controller (NIC) 106.

The CPU 101 realizes the function of the transfer processing unit 13 described in FIG. 1.

The main memory 102 realizes the storage unit 14 described in FIG. 1.

The GPU 103 realizes the forward propagation calculation unit 11 and the backpropagation calculation unit 12 described in FIG. 1. The GPU 103 includes a memory 104 and a transfer buffer 105.

The memory 104 realizes the storage units 110 and 120 included in the forward propagation calculation unit 11 and the backpropagation calculation unit 12 described in FIG. 1.

The transfer buffer 105 realizes the transfer buffers 111 and 121 included in the forward propagation calculation unit 11 and the backpropagation calculation unit 12 described in FIG. 1.

The NIC 106 realizes the communication unit 15 described in FIG. 1. The NIC 106 includes a transfer buffer 107, and the transfer buffer 107 corresponds to the transfer buffer 150 included in the communication unit 15 in FIG. 1.

As described above, the Allreduce processing apparatus 2 in FIG. 1 is also realized by a computer formed in a similar manner as the computers 1 described above.

### Overview of Data Flow of Data Transfer Processing

Next, an overview of data transfer processing performed by the distributed deep learning system according to this embodiment is described with reference to FIG. 2 and FIG. 3.

As illustrated in FIG. 3, in the GPU 103, the backpropagation calculation for each layer is performed, and the calculation results of the layers are stored in the memory 104 of the GPU 103 in order. In parallel with the above, the results of the backpropagation calculation for the layers stored in the memory 104 of the GPU 103 are transferred to the main memory 102 in the order in which the calculation results are calculated. In parallel with the above, the results of the backpropagation calculation for the layers are transferred from the main memory 102 to the transfer buffer 107 of the NIC 106 in order in accordance with the instruction of the CPU 101.

In parallel with the above, the NIC 106 transmits the incoming results of the backpropagation calculation for the layers to the Allreduce processing apparatus 2 over the communication network in order. The Allreduce processing apparatus 2 performs the Allreduce processing on the results of the backpropagation calculation for the layers and returns the outputs of the Allreduce processing for the layers to the NIC 106 over the communication network.

In parallel with the above, the outputs of the Allreduce processing for the layers stored in the transfer buffer 107 of the NIC 106 are transferred to the main memory 102 in order. In parallel with the above, the GPU 103 acquires the outputs for the layers on which the Allreduce processing has been performed from the main memory 102 and executes the forward propagation calculation.

As described above, in this embodiment, in each of the computers 1, the results of the backpropagation calculation calculated for the layers in order are transferred in the output order thereof, the Allreduce processing is performed for each layer, the results are returned to each of the computers 1 again, and the forward propagation calculation is performed.

### Data Transfer Method

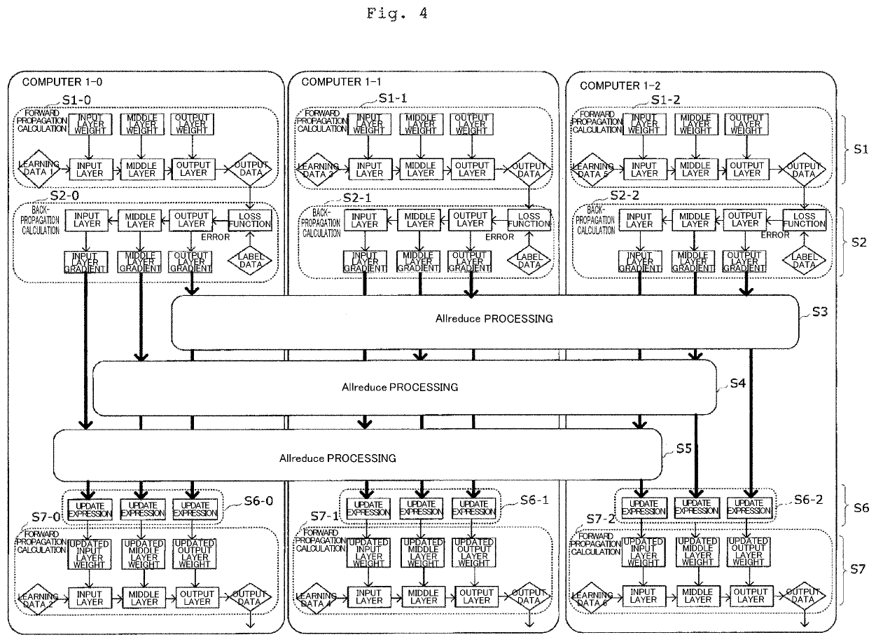

Next, the details of a data transfer method of this embodiment described above are described with reference to FIG. 4.

As illustrated in FIG. 4, each of the computers 1-0 to 1-2 forming the distributed deep learning system performs the forward propagation calculation (Steps S1-0, S1-1, and S1-2). In more detail, the learning data input units 10 input learning data 1, 3, and 5 to the forward propagation calculation units 11 of the computers 1-0 to 1-2 in accordance with inputs from the outside.

More specifically, the learning data 1, 3, and 5 are input to input layers of the forward propagation calculation units 11 with weight parameters of the input layers. Results of the multiply-add operation of the weight parameters and the learning data in the input layers are input to middle layers, and the multiply-add operation with weight parameters of the middle layers is performed. Outputs of the middle layers are used as inputs of output layers, the multiply-add operation with weight parameters are performed in the output layers, and results thereof are stored in the storage units 110 as results of the forward propagation calculation of the neural network.

Then, the backpropagation calculation units 12 of the computers 1-0 to 1-2 define the loss functions L of which variables are the results of the forward propagation calculation and calculate the gradients of the layers in the order of the output layer, the middle layer, and the input layer (backpropagation calculation: Steps S2-0, S2-1, and S2-2). In more detail, the gradients of the layers are stored in the transfer buffers 121 in the order from the gradients of the output layers calculated by the backpropagation calculation units 12, and are transferred to the storage units 14 that are the main memories of the computers 1-0 to 1-2 in accordance with the order.

When the transfer processing units 13 instruct the communication units 15 to transmit the gradients, the communication units 15 read out the gradients for the layers stored in the storage units 14 in the stored order and store the gradients in the transfer buffer 150. The communication units 15 transmit the gradients of the output layers to the Allreduce processing apparatus 2 first. The Allreduce processing apparatus 2 that has received the gradients of the output layers executes the Allreduce processing when the gradients of the output layers calculated in the computers 1-0 to 1-2 are gathered (Step S3).

Then, the communication units 15 similarly transmit the gradients of the middle layers to the Allreduce processing apparatus 2. The Allreduce processing apparatus 2 that has received the gradients of the middle layers executes the Allreduce processing when the gradients of the middle layers calculated in the computers 1-0 to 1-2 are gathered (Step S4).

Then, the communication units 15 similarly transmit the gradients of the input layers to the Allreduce processing apparatus 2. The Allreduce processing apparatus 2 that has received the gradients of the input layers executes the Allreduce processing when the gradients of the input layers calculated in the computers 1-0 to 1-2 are gathered (Step S5).

Next, update expressions of the weight parameters of the output layers, the middle layers, and the input layers are defined (Steps S6-0, S6-1, and S6-2) on the basis of the gradient information of the output layers, the gradient information of the middle layers, and the gradient information of the input layers on which the Allreduce processing has been performed that are output in Step S3 to Step S5. For example, the Allreduce processing apparatus 2 may return the update expressions of the weight parameters of the layers to the communication units 15 of the computers 1-0 to 1-2 over the communication network as outputs of the Allreduce processing.

Then, the forward propagation calculation units 11 of the computers 1-0 to 1-2 perform the forward propagation calculation (Steps S7-0, S7-1, and S7-2) on the basis of the received gradient information of the layers on which the Allreduce processing has been performed. In more detail, the communication units 15 of the computers 1-0 to 1-2 temporarily store the update expressions of the weight parameters of the layers based on the received outputs of the Allreduce processing in the transfer buffers 150 and transfer the update expressions to the storage units 14.

Then, the forward propagation calculation units 11 read out the update expressions for the layers from the storage units 14 and store the update expressions in the transfer buffers 111 of the forward propagation calculation units 11. The forward propagation calculation units 11 perform the forward propagation calculation by using new learning data 2, 4, and 6 and the updated weights of the layers as inputs. Then, the results of the forward propagation calculation are input to the backpropagation calculation units 12 again. The forward propagation calculation units 11 obtain the updated weight parameters for the layers with use of the update expressions of the layers in advance.

As described above, according to the distributed deep learning system according to Embodiment 1, as soon as the results of the backpropagation calculation of the layers are calculated, the gradient information of the layers are transferred from the memory 104 of the GPU 103 to the main memory 102, and the Allreduce processing is performed for each layer. In the distributed deep learning system according to Embodiment 1, the backpropagation calculation and the Allreduce processing can be executed in parallel with each other, and hence the waiting time from the backpropagation calculation to the start of the forward propagation calculation can be decreased and the distributed deep learning processing can be performed at a higher speed.

In the distributed deep learning system according to Embodiment 1, not all of the gradient information of the layers of the multilayered neural network necessarily need to be placed in the transfer buffer 107 of the NIC 106, and hence the downsizing and power saving of the NICs become possible.

The distributed deep learning system according to Embodiment 1 does not necessarily need to transmit and receive a large amount of data at once, and hence becomes robust to packet loss and the like.

In the distributed deep learning system according to Embodiment 1, the use rate of the CPU 101 can be decreased, and hence the power consumption can be decreased, and the heat generation can be suppressed.

### Modified Example 1

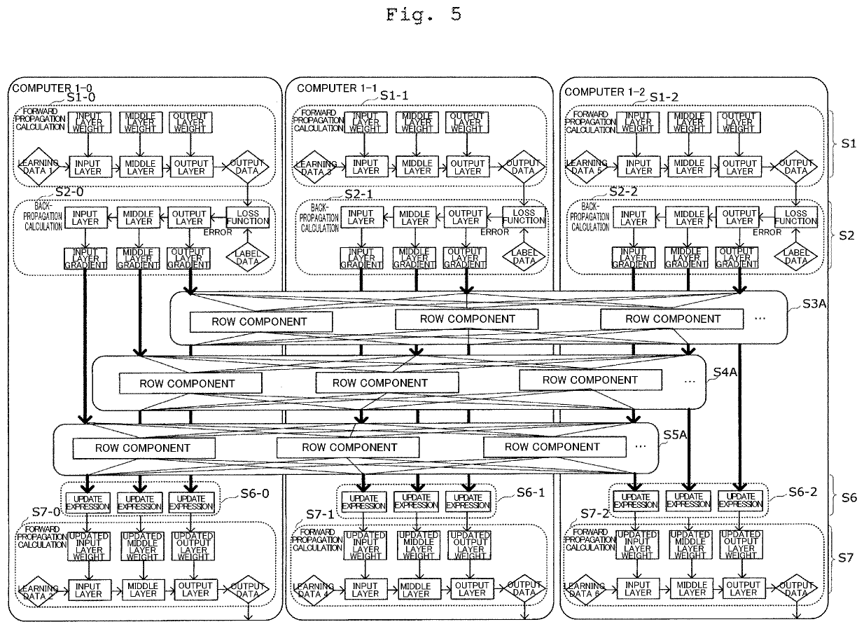

Next, Modified Example 1 of Embodiment 1 is described with reference to FIG. 5.

As described above, the GPU 103 is a device capable of executing a plurality of processing in parallel with each other. The backpropagation calculation executed by the GPU 103 (backpropagation calculation unit 12) is performed as a matrix operation. The matrix operation is executed by an algorithm called blocking (tiling). This method is an approach of accelerating the calculation by reusing the data in a cache (not shown) included in the GPU 103.

For example, for a matrix product of A×B=C, a vector product with the column components of B is executed while leaving the matrix components of A in the cache. The row components of A remains in the cache until the calculation for one row of C ends. By using one row of C as a unit, the operation result for one row is transferred from the memory 104 of the GPU 103 to the main memory 102 as soon as the operation for the one row ends. Then, the Allreduce processing for the row components of the layers is executed in the Allreduce processing apparatus 2 (Steps S3A, S4A, and S5A in FIG. 5). The sizes of the transferred data differ between layers but are the same within each of the layers.

As described above, in Modified Example 1, the Allreduce processing for each row component of each layer is executed by tiling in the backpropagation calculation, and hence the transferred data amount can be decreased.

### Modified Example 2

Next, Modified Example 2 of Embodiment 1 is described with reference to FIG. 6.

In Modified Example 1, data transfer that focuses on the point in which the backpropagation calculation is performed as the matrix operation has been described. In a distributed deep learning system according to Modified Example 2, the Allreduce processing is executed for each matrix element of each layer in the Allreduce processing apparatus 2.

The gradient information is generally a matrix or a vector. Therefore, as soon as the operation of the components of the matrices or the vectors of the gradient information of the layers ends in the GPUs 103 (backpropagation calculation units 12), the components for the layers are transferred from the memories 104 of the GPUs 103 to the main memories 102. Then, the components for the layers are transmitted to the Allreduce processing apparatus 2 from the NICs 106, and the Allreduce processing is executed for the matrix elements of the output layers, for example (Step S3B). Similarly, the Allreduce processing is executed for each matrix element also for the middle layers and the input layers (Steps S4B and S5B).

As described above, the Allreduce processing is performed by transferring data for each component of the matrix or the vector of each layer, and hence the transferred data amount can be decreased more. The sizes of the transferred data are the same.

### Embodiment 2

Next, Embodiment 2 of the present invention is described. In the description below, the same configurations as those in Embodiment 1 described above are denoted by the same reference characters, and descriptions thereof are omitted.

In Embodiment 1, a case where the backpropagation calculation and the Allreduce processing are executed in parallel with each other has been described. Meanwhile, in Embodiment 2, the Allreduce processing and the forward propagation calculation are executed in parallel with each other. Configurations different from those of Embodiment 1 are mainly described below.

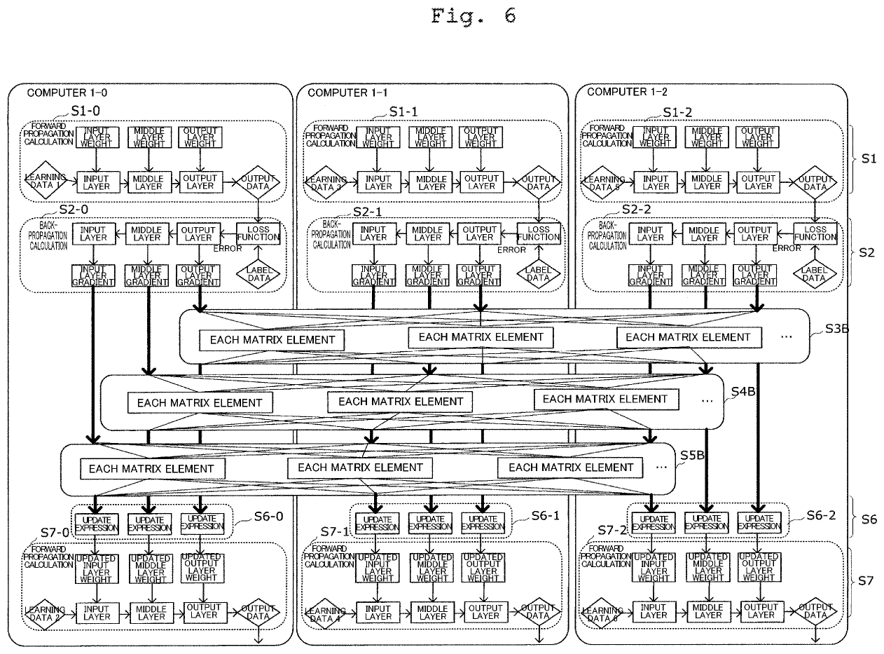

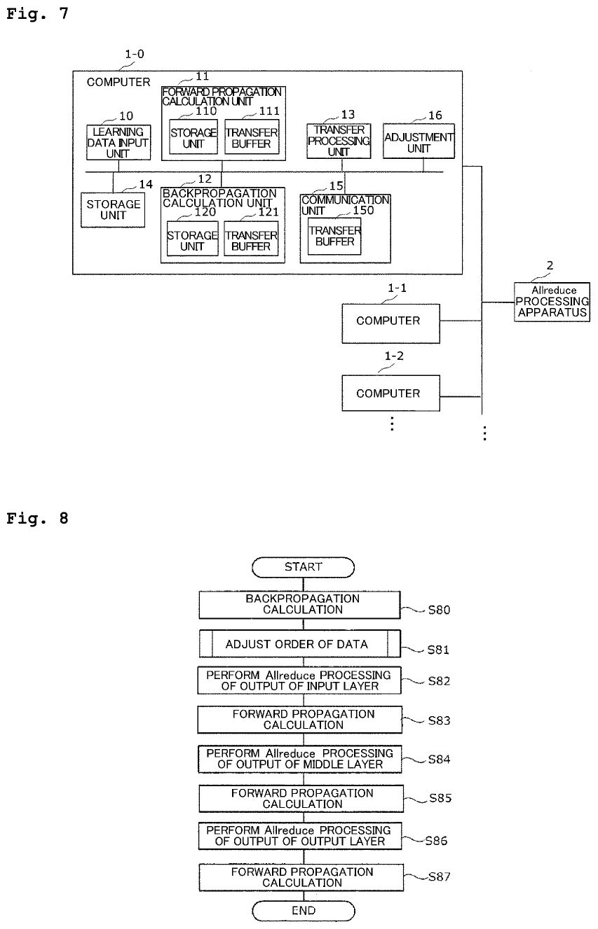

As illustrated in FIG. 7, in a distributed deep learning system according to Embodiment 2, each of the computers 1-0 to 1-2 further includes an adjustment unit 16 that changes the order of the transfer data. The hardware configuration of each of the computers 1 forming the distributed deep learning system of Embodiment 2 is similar to that of Embodiment 1 (FIG. 2). The adjustment unit 16 is realized by the CPU 101 illustrated in FIG. 2.

In each of the computers 1-0 to 1-2, the adjustment unit 16 performs adjustment such that the calculation results of the backpropagation calculation for the layers on which the Allreduce processing has been performed included in input data input to the forward propagation calculation unit 11 are in the order of an input layer, a middle layer, and an output layer.

The adjustment unit 16 causes the order of the calculation results of the backpropagation calculation for the layers stored in the storage unit 14 to be in reverse order before transmitting the calculation results to the Allreduce processing apparatus 2, for example.

As described above, the GPU 103 that realizes the forward propagation calculation unit 11 and the backpropagation calculation unit 12 is a device that can execute a plurality of processing in parallel with each other. Therefore, the GPU 103 can execute the forward propagation calculation while acquiring the gradient information for each layer on which the Allreduce processing has been performed from the storage unit 14 that is a main memory of each of the computers 1.

In the forward propagation calculation, the calculation is performed in the order of the input layer, the middle layer, and the output layer, and the results of the Allreduce processing in the layers are necessary when the forward propagation calculation is started (Steps S6-0 to S6-2 and Steps S7-0 to S7-2 in FIG. 4). In other words, in the forward propagation calculation, the multiply-add operation is performed in the order from the input layer by using the new learning data and the updated weight parameters of the layers acquired with use of the gradient information on which the Allreduce processing has been performed as the inputs.

Meanwhile, in the backpropagation calculation, the gradients are output by performing calculation in the order of the output layer, the middle layer, and the input layer. Therefore, the adjustment unit 16 according to this embodiment changes the order of the gradients on which the Allreduce processing has been performed that are input to the forward propagation calculation unit 11 to an order of the input layer, the middle layer, and the output layer.

### Data Transfer Method

Next, the operation of the distributed deep learning system according to this embodiment is described with reference to flowcharts of FIG. 8 to FIG. 10. First, the backpropagation calculation unit 12 performs the backpropagation calculation for each layer in the order of the output layer, the middle layer, and the input layer (Step S80). The results of the backpropagation calculation for the layers are stored in the storage unit 120. At this time, in the order of the output layer, the middle layer, and the input layer, the results of the backpropagation calculation are stored in the transfer buffer 121 and are sequentially transferred to the storage unit 14 that is the main memory of each of the computers 1 in accordance with the instruction of the transfer processing unit 13.

Next, the adjustment unit 16 adjusts the order in which the results of the backpropagation calculation of the layers transferred to the storage unit 14 are stored (Step S81). In more detail, the adjustment unit 16 changes the order of the gradients of the layers that are the results of the backpropagation calculation transferred to the storage unit 14 in the order of the output layer, the middle layer, and the input layer to the order of the input layer, the middle layer, and the output layer and stores the gradients in the storage unit 14. Then, the communication unit 15 transmits the results of the backpropagation calculation stored in the storage unit 14 to the Allreduce processing apparatus 2 in the order of the input layer, the middle layer, and the output layer on the basis of the instruction of the transfer processing unit 13.

Then, the Allreduce processing apparatus 2 performs the Allreduce processing for the gradient of the input layer received first (Step S82). The output of the Allreduce processing is returned to the communication unit 15 over a communication network and is stored in the transfer buffer 150. The transfer processing unit 13 sends a transfer instruction for the data to the communication unit 15, and the communication unit 15 stores the gradient of the input layer on which the Allreduce processing has been performed in the storage unit 14.

Next, the forward propagation calculation unit 11 acquires the gradient information of the input layer on which the Allreduce processing has been performed from the storage unit 14 and executes the forward propagation calculation of the input layer (Step S83). In more detail, the forward propagation calculation unit 11 acquires the gradient information of the input layer on which the Allreduce processing has been performed from the storage unit 14 and stores the gradient information in the transfer buffer 111. Then, the forward propagation calculation unit 11 calculates the updated weight parameter on the basis of the acquired gradient information of the input layer and performs the multiply-add operation of the input layer by using the learning data and the updated weight parameter as inputs. The result of the forward propagation calculation in the input layer is stored in the storage unit 110.

Next, the Allreduce processing apparatus 2 performs the Allreduce processing for the gradient of the middle layer received after the input layer (Step S84). Then, the forward propagation calculation unit 11 similarly acquires the gradient information of the middle layer on which the Allreduce processing has been performed from the storage unit 14 and executes the forward propagation calculation of the middle layer (Step S85).

Then, the Allreduce processing apparatus 2 performs the Allreduce processing for the gradient of the output layer received after the result of the backpropagation calculation of the middle layer (Step S86). Then, the forward propagation calculation unit 11 similarly acquires the gradient information of the output layer on which the Allreduce processing has been performed from the storage unit 14 and executes the forward propagation calculation of the output layer (Step S87).

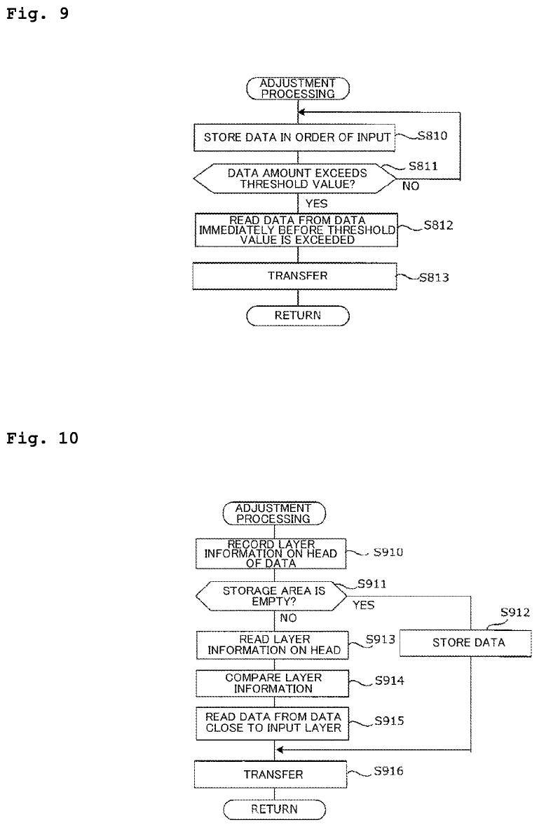

Now, adjustment processing performed by the adjustment unit 16 in Step S81 is described with reference to FIG. 8 and FIG. 9.

The adjustment of the data order performed by the adjustment unit 16 is so-called data first-in last-out processing. The adjustment unit 16 can perform the adjustment processing by a well-known last-in first-out (LIFO) method as that illustrated in FIG. 8, for example. As another example, the adjustment unit 16 can perform the adjustment processing by a well-known cut-through method.

First, the processing of the adjustment unit 16 performed by the LIFO method is described. As illustrated in FIG. 8, the adjustment unit 16 stores the data in the storage unit 14 in the order in which the data is transferred from the backpropagation calculation unit 12 to the storage unit 14 (Step S810). Specifically, the adjustment unit 16 stores the gradients that are the calculation results of the backpropagation calculation transferred in the order of the output layer, the middle layer, and the input layer in a predetermined area of the storage unit 14 in the order of transfer.

Next, when the data amount stored in the predetermined area of the storage unit 14 is equal to or less than a set threshold value (Step S811: NO), the transferred data is continuously stored in the storage unit 14 (Step S810).

Meanwhile, when the data amount stored in the predetermined area of the storage unit 14 exceeds the set threshold value (Step S811: YES), the adjustment unit 16 instructs the communication unit 15 to read data from data immediately before the threshold value is exceeded (Step S812). The communication unit 15 reads data in the order from the data immediately before the threshold value is exceeded and stores the data in the transfer buffer 150.

Then, the communication unit 15 transmits (transfers) the data stored in the transfer buffer 150 to the Allreduce processing apparatus 2 in the read order over the communication network (Step S813). When the adjustment unit 16 reads out all of the data stored in the predetermined area of the storage unit 14 in Step S812, the adjustment unit 16 moves to Step S810 again and stores the result of the backpropagation calculation for each layer in an area of the storage unit 14. Then, the processing returns to Step S82 in FIG. 8, and the Allreduce processing and the forward propagation calculation are executed.

Next, a case where the adjustment unit 16 performs the adjustment processing by a well-known cut-through method is described with reference to a flowchart of FIG. 10.

First, the adjustment unit 16 records layer information of the data of the gradient for each layer that is the result of the backpropagation calculation transferred to the storage unit 14 on the head of the data (Step S910). Next, when a preset area of the storage unit 14 is empty (Step S911: YES), the storage unit 14 stores the data in the set area (Step S912).

Meanwhile, when data is stored in a storage area set in the storage unit 14 (Step S911: NO), the adjustment unit 16 reads the layer information on the head of the data to be stored (Step S913). Then, the read layer information of the data to be stored and the layer information of the data stored in the set area of the storage unit 14 first are compared with each other (Step S914).

In more detail, the adjustment unit 16 determines which of the layer information of the data to be stored and the layer information of the data that is already stored is data close to the input layer by comparison. Then, the adjustment unit 16 instructs the communication unit 15 to read the data in the order from the data close to the input layer (Step S915). The communication unit 15 stores the data in the transfer buffer 150 in the order from the data close to the input layer.

Then, the communication unit 15 transfers (transmits) the data stored in the transfer buffer 150 to the Allreduce processing apparatus 2 in the stored order (Step S916). Then, the processing returns to Step S82 in FIG. 8, and the Allreduce processing and the forward propagation calculation are executed. When all of the data stored in the transfer buffer 150 is transmitted in Step S916, the recording (processing in Step S910 and steps thereafter) of the layer information for the data of the result of the backpropagation calculation for each layer to be transferred starts again.

A case where the abovementioned adjustment unit 16 adjusts the order of transfer of the calculation results of the layers transferred from the backpropagation calculation unit 12 to the storage unit 14 and stored in the storage unit 14 has been described as an example. However, other configurations may be employed as long as the adjustment unit 16 can adjust the order of the input data input to the forward propagation calculation unit 11 to be the order of the input layer, the middle layer, and the output layer.

For example, the adjustment unit 16 may adjust the order of those data at a timing at which the results of the backpropagation calculation stored in the storage unit 14 are transferred to the communication unit 15. Specifically, the adjustment unit 16 may perform adjustment by changing the order of the data to be stored in the transfer buffer 150 to the order from the result of the backpropagation calculation of the layer close to the input layer when the results of the backpropagation calculation are transmitted to the Allreduce processing apparatus 2 in Step S81 in FIG. 8.

The adjustment unit 16 can also use the first-in last-out processing described in FIG. 9 or FIG. 10 in this example.

In the abovementioned description, a case where the adjustment unit 16 adjusts the order of the data before the Allreduce processing has been described as an example. However, the adjustment unit 16 may change the order of the data after or in the middle of the Allreduce processing as long as the adjustment unit 16 can adjust the data to be input to the forward propagation calculation unit 11 to be in the order from the input layer to the output layer as described above.

As described above, according to the distributed deep learning system according to Embodiment 2, the results of the backpropagation calculation output in the order of the output layer, the middle layer, and the input layer are changed to be in the order of the input layer, the middle layer, and the output layer, and hence the forward propagation calculation executed in the GPU 103 (forward propagation calculation unit 11) and the Allreduce processing can be performed in parallel with each other. Therefore, the waiting time from the backpropagation calculation to the start of the forward propagation calculation can be decreased, and the distributed deep learning processing can be performed at a higher speed.

According to the distributed deep learning system according to Embodiment 2, not all of the gradient information of the layers of the multilayered neural network necessarily need to be placed in the transfer buffer 107 of the NIC 106, and hence the downsizing and power saving of the NICs become possible.

The distributed deep learning system according to Embodiment 2 does not necessarily need to transmit and receive a large amount of data, and hence is robust to packet loss and the like.

According to the distributed deep learning system according to Embodiment 2, the use rate of the CPU 101 can be decreased, which enables the decrease of power consumption and the decrease of heat generation.

### Modified Example

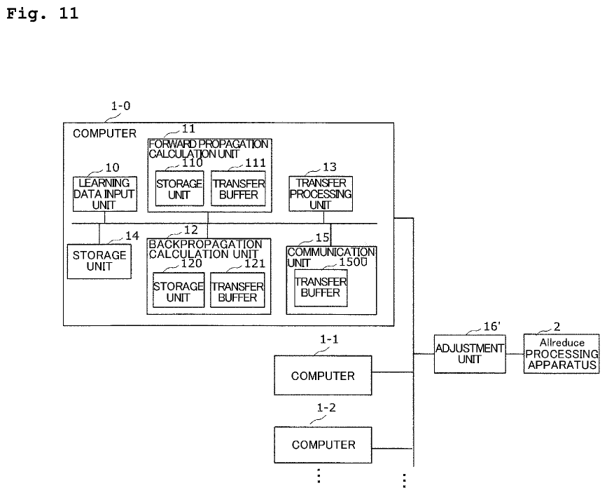

Next, a distributed deep learning system according to a modified example of Embodiment 2 is described with reference to FIG. 11. As illustrated in FIG. 11, the distributed deep learning system according to the modified example includes an adjustment unit 16′ connected to the computers 1-0 to 1-2 and the Allreduce processing apparatus 2 over a communication network. In this modified example, the adjustment unit 16′ adjusts the order of data in the middle of Allreduce processing. The function of the adjustment unit 16′ is similar to that of the adjustment unit 16 described in Embodiment 2.

The adjustment unit 16′ can be formed by a network switch, for example. The adjustment unit 16′ causes the order of the results of the backpropagation calculation transmitted in the order of the output layer, the middle layer, and the input layer via the communication unit 15 of each of the computers 1 to be a reverse order and transfers the results to the Allreduce processing apparatus 2 in the order from the layer close to the input layer. The Allreduce processing apparatus 2 preferentially performs the Allreduce processing on the result of the backpropagation calculation of the layer close to the input layer.

In the abovementioned modified example, the LIFO method and the cut-through method described in FIG. 9 or FIG. 10 can also be employed for the adjustment unit 16′.

### Embodiment 3

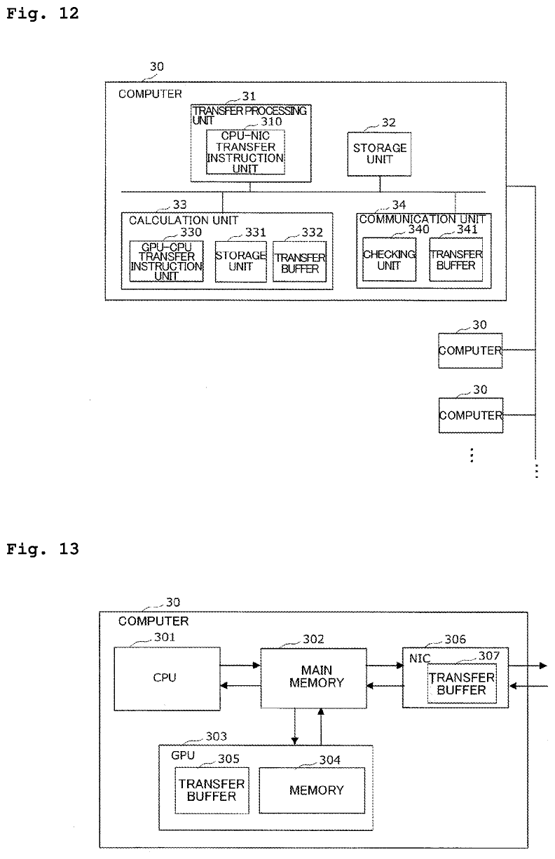

Next, Embodiment 3 of the present invention is described with reference to FIG. 12 and FIG. 13. In the description below, the same configurations as those in Embodiment 1 and Embodiment 2 described above are denoted by the same reference characters, and descriptions thereof are omitted.

In a distributed deep learning system according to Embodiment 3, in each of computers 30, the data transfer between a memory 304 included in a GPU 303 and a memory of a CPU 301, that is, a main memory 302 of the computer 30 is executed by an order of the GPU 303, and the data transfer between the main memory 302 and a transfer buffer 307 of an NIC 306 is executed by an order of the CPU 301.

The distributed deep learning system according to this embodiment includes at least one computer 30. For example, as illustrated in FIG. 12, in the distributed deep learning system, the plurality of computers 30 are connected to each other over a communication network. The computers 30 have similar configurations.

As illustrated in FIG. 12, the computer 30 includes a transfer processing unit 31, a storage unit 32, a calculation unit 33, and a communication unit 34.

The transfer processing unit 31 includes a CPU-NIC transfer instruction unit 310 (first transfer instruction unit). The transfer processing unit 31 transfers data stored in the storage unit 32 that is a main memory of the computer 30 to the communication unit 34.

The CPU-NIC transfer instruction unit 310 instructs the communication unit 34 to transfer data received from another computer 30, an Allreduce processing apparatus (not shown), and the like connected to the computer 30 over the communication network to the storage unit 32. The CPU-NIC transfer instruction unit 310 instructs the communication unit 34 to transfer data to be transmitted to the outside from the storage unit 32 to the communication unit 34.

The storage unit 32 is the main memory included in the computer 30. The storage unit 32 stores the calculation result of the calculation unit 33 to be transmitted from the computer 30 to the outside in a preset area. Data received from the outside is transferred to the storage unit 32 and is stored in a preset area. For example, the result of backpropagation calculation and the like on which Allreduce processing has been performed from the outside are stored in a set area of the storage unit 32.

The calculation unit 33 includes a GPU-CPU transfer instruction unit 330 (second transfer instruction unit), a storage unit 331, and a transfer buffer 332. The calculation unit 33 performs forward propagation calculation and the backpropagation calculation of a neural network, for example.

The GPU-CPU transfer instruction unit 330 transfers data to the storage unit 32 and acquires data from the storage unit 32.

The storage unit 331 stores therein the result of calculation executed by the calculation unit 33.

The transfer buffer 332 reads out the calculation result stored in the storage unit 331 and temporarily stores the calculation result therein. The data stored in the transfer buffer 332 is transferred to the storage unit 32 in accordance with an instruction from the GPU-CPU transfer instruction unit 330.

The transfer buffer 332 temporarily stores therein data acquired from the storage unit 32 in accordance with an instruction of the GPU-CPU transfer instruction unit 330. The data received from the outside and stored in the transfer buffer 332 is used when the calculation unit 33 performs a calculation. For example, the calculation unit 33 performs the forward propagation calculation with use of gradient information of layers on which the Allreduce processing has been performed received from the outside.

The communication unit 34 includes a checking unit 340 and a transfer buffer 341. The communication unit 34 is an interface that exchanges data with another computer 30 connected to the computer 30 over the communication network.

The communication unit 34 transfers the data received from the outside to the storage unit 32 on the basis of an instruction from the transfer processing unit 31. The communication unit 34 acquires the data transferred to the storage unit 32 from the calculation unit 33 on the basis of the instruction from the transfer processing unit 31 and transmits the data to the outside.

The checking unit 340 checks whether there is space in a set area of the storage unit 32 when the communication unit 34 transfers data received from the outside to the storage unit 32. The checking unit 340 checks whether data to be transmitted to the outside by the communication unit 34 is stored in the set area of the storage unit 32.

The transfer buffer 341 temporarily stores therein data received from the outside by the communication unit 34. The transfer buffer 341 temporarily stores therein the data to be transmitted to the outside by the communication unit 34.

### Hardware Configuration of Computer

Next, a hardware configuration of the computer 30 according to this embodiment is described with reference to FIG. 13.

As illustrated in FIG. 13, the computer 30 includes the CPU 301, the main memory 302, the GPU 303, and the NIC 306.

The CPU 301 realizes the function of the transfer processing unit 13 described in FIG. 12.

The main memory 302 realizes the storage unit 32 described in FIG. 12.

The GPU 303 realizes the calculation unit 33 described in FIG. 12. The GPU 303 includes the memory 304 and the transfer buffer 305. The GPU 303 acquires data from the main memory 302 and transfers the result of calculation by the GPU 303 to the main memory 302. The GPU 303 executes the backpropagation calculation for each layer of the neural network and the transfer of the results of the backpropagation calculation to the main memory 302 in parallel with each other, for example.

The memory 304 included in the GPU 303 realizes the storage unit 331 described in FIG. 12.

The transfer buffer 305 realizes the transfer buffer 332 included in the calculation unit 33 described in FIG. 12.

The NIC 306 realizes the communication unit 34 described in FIG. 12. The NIC 306 includes the transfer buffer 307, and the transfer buffer 307 corresponds to the transfer buffer 341 included in the communication unit 34 in FIG. 12.

### Data Transfer Processing

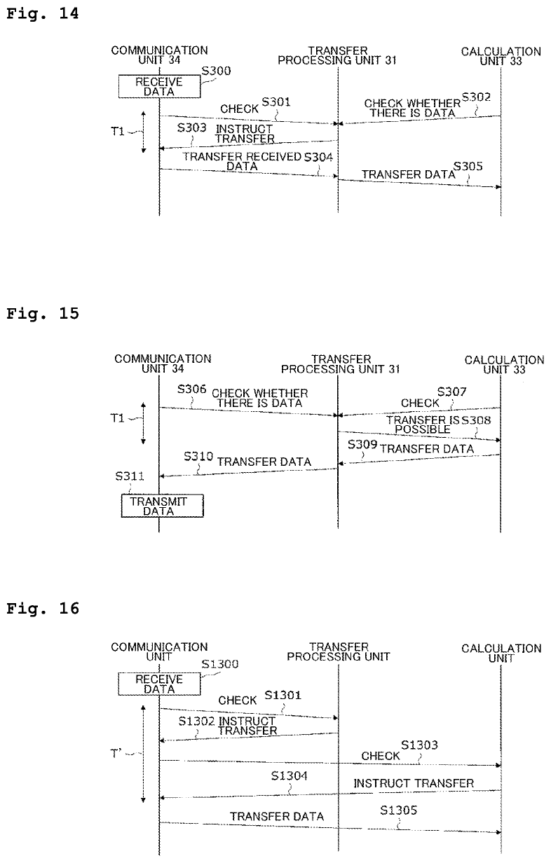

An operation sequence of the computer 30 having the configuration described above is described with reference to FIG. 14 to FIG. 16. First, data transfer processing when the computer 30 receives data from the outside is described.

As illustrated in FIG. 14, the communication unit 34 receives data from the outside over the communication network (Step S300). The communication unit 34 stores the received data in the transfer buffer 341 in Step S300.

Next, the checking unit 340 checks that there is space in a set area of the storage unit 32 that is the transfer destination of the received data (Step S301). In more detail, the checking unit 340 checks the empty area of the storage unit 32 via the transfer processing unit 31.

Meanwhile, the GPU-CPU transfer instruction unit 330 of the calculation unit 33 checks whether the received data to be acquired is transferred to and stored in the storage unit 32 (Step S302). As described above, the communication unit 34 and the calculation unit 33 asynchronously check the storage unit 32.

Then, the CPU-NIC transfer instruction unit 310 instructs the communication unit 34 to store data in the set area of the storage unit 32 (Step S303). Then, the communication unit 34 transfers the received data stored in the transfer buffer 341 to the storage unit 32 (Step S304). Next, the GPU-CPU transfer instruction unit 330 of the calculation unit 33 acquires the data from the storage unit 32 (Step S305) when the GPU-CPU transfer instruction unit 330 checks that there is data transferred to the storage unit 32 in Step S302. The acquired data is stored in the transfer buffer 332 of the calculation unit 33.

Next, a case where the computer 30 outputs data to the outside is described with reference to FIG. 15.

As illustrated in FIG. 15, the checking unit 340 included in the communication unit 34 checks whether data to be transmitted to the outside is stored in the storage unit 32 (Step S306). In more detail, the checking unit 340 checks whether there is data in the storage unit 32 via the transfer processing unit 31.

Meanwhile, the GPU-CPU transfer instruction unit 330 of the calculation unit 33 checks whether there is space in a set area of the storage unit 32 (Step S307). As described above, the communication unit 34 and the calculation unit 33 asynchronously check the storage unit 32.

Then, when the GPU-CPU transfer instruction unit 330 checks that the storage unit 32 has an empty area (Step S308), the GPU-CPU transfer instruction unit 330 transfers the data stored in the transfer buffer 332 to the storage unit 32 (Step S309). Then, when the communication unit 34 checks that the transfer data from the calculation unit 33 is stored in the storage unit 32 in Step S306, the communication unit 34 acquires the data from the storage unit 32 (Step S310). The communication unit 34 stores the data in the transfer buffer 341 and transmits the data to the external computer 30 and the like over the communication network (Step S311).

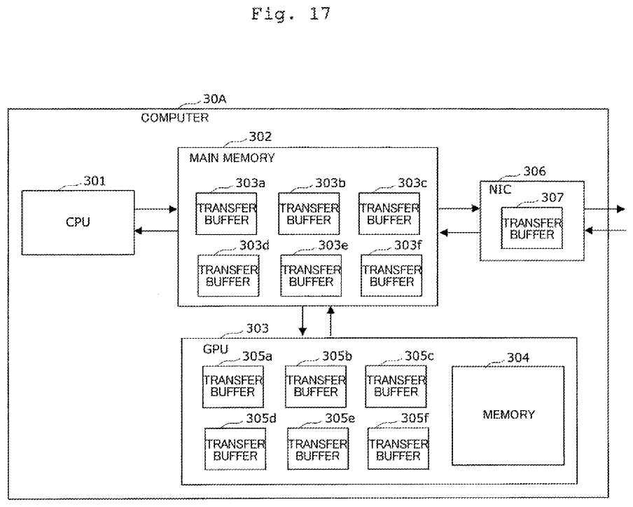

Now, data transfer processing of a related-art example is described with reference to FIG. 16 for the sake of comparison with the data transfer processing in the distributed deep learning system according to this embodiment.

As illustrated in FIG. 16, in the related-art example, a communication unit first receives data from the outside over a communication network (Step S1300). Next, the communication unit checks whether there is space in a predetermined area of a storage unit via a transfer processing unit (Step S1301). When the communication unit checks that there is space in the predetermined area of the storage unit, the communication unit receives a transfer instruction from the transfer processing unit (Step S1302).

Next, the communication unit checks that a storage unit included in a calculation unit has an empty area on the basis of an instruction from the transfer processing unit (Step S1303). When the communication unit checks that the calculation unit has an empty area, the communication unit receives a transfer instruction via the transfer processing unit (Step S1304).

Then, the communication unit transfers the received data from a transfer buffer to the storage unit that is a main memory of a computer and the storage unit of the calculation unit (Step S1305).

Now, in the data transfer processing in the distributed deep learning system according to this embodiment described in FIG. 14 and FIG. 15, buffer check between the communication unit 34 and the transfer processing unit 31 (storage unit 32) and buffer check between the calculation unit 33 and the transfer processing unit (storage unit 32) are asynchronously performed. Therefore, time T1 necessary for the buffer check in this embodiment is shorter than time T′ necessary for buffer check performed in a synchronous manner in the data transfer processing of the related-art example described in FIG. 16.

As described above, the distributed deep learning system according to Embodiment 3 transfers data between the GPU 303 and the main memory 302 by the instruction of the calculation unit 33 (GPU 303) and transfers data between the communication unit 34 (NIC 306) and the main memory 302 by the instruction of the transfer processing unit 31 (CPU 301). The transfer delay in the computer 30 can be decreased by asynchronously transferring data as described above.

The distributed deep learning system according to this embodiment can transfer the data of the transfer buffer 307 of the NIC 306 to the main memory 302 with low delay, and hence can decrease the waiting time for receipt when data is received from the outside.

The distributed deep learning system according to this embodiment asynchronously performs the data transfer by dividing the process, and hence is robust to an overflow of the transfer buffer 307 of the NIC 306.

According to the distributed deep learning system according to this embodiment, the time during which the transfer buffers included in the devices forming the computer 30 are empty is decreased, and hence the waiting time for the transmission and reception of data in the NIC 306 can be decreased.

According to the distributed deep learning system according to this embodiment, the use rate of the CPU 301, the power consumption, and the heat generation can be decreased.

The distributed deep learning system according to this embodiment executes another processing during the interval time in which the CPU 301 is not used, and hence can also accelerate processing other than data transfer.

The distributed deep learning system according to this embodiment can perform data transfer in each of the computers 30 in a more efficient manner, and hence can perform the distributed deep learning processing at a higher speed.

### Embodiment 4

Next, Embodiment 4 of the present invention is described. In the description below, the same configurations as those in Embodiment 1 to Embodiment 3 described above are denoted by the same reference characters, and descriptions thereof are omitted.

In Embodiment 3, a case where the CPU 301 and the GPU 303 asynchronously perform the instruction of the data transfer in the computer has been described. Meanwhile, in Embodiment 4, each of the main memory 302 and the GPU 303 further includes a plurality of transfer buffers. Configurations different from those of Embodiment 1 to Embodiment 3 are mainly described below.

As illustrated in FIG. 17, a computer 30A forming a distributed deep learning system according to this embodiment includes the CPU 301, the main memory 302, the GPU 303, and the NIC 306. The main memory 302 includes a plurality of transfer buffers 303a to 303f. The GPU 303 also includes a plurality of transfer buffers 305a to 305f.

The functional configurations of the distributed deep learning system according to this embodiment and the computer 30A forming the distributed deep learning system are similar to those of Embodiment 3 (FIG. 12).

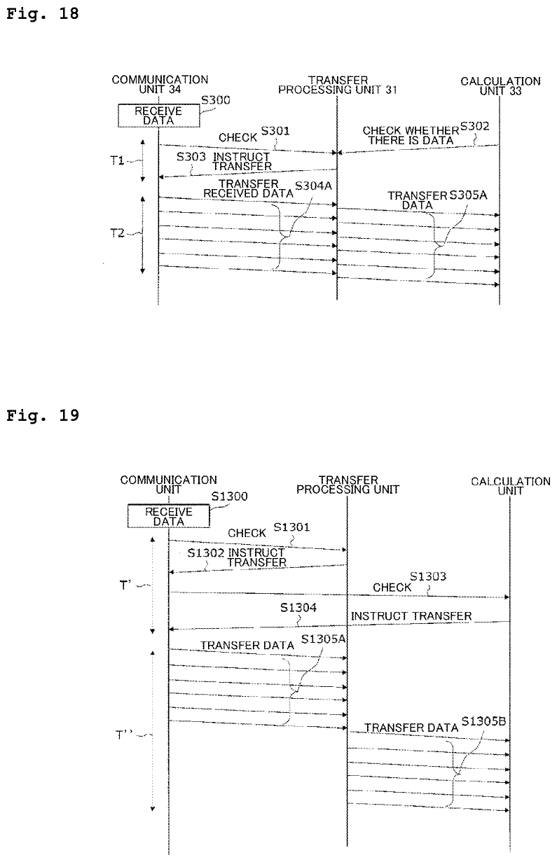

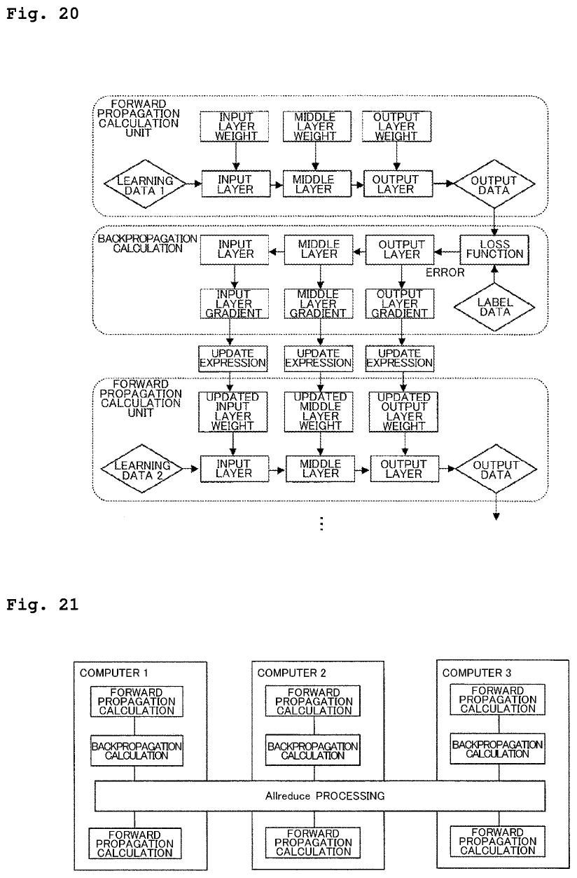

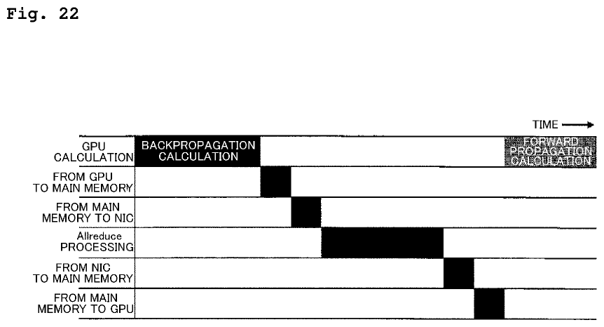

Next, data transfer processing in the computer 30A according to this embodiment is described with reference to sequence diagrams of FIG. 18 and FIG. 19.

As illustrated in FIG. 18, the communication unit 34 receives data from the outside over a communication network (Step S300). In more detail, the communication unit 34 stores the received data in the transfer buffer 341 in Step S300.

Next, the checking unit 340 checks that there is space in a set area of the storage unit 32 that is the transfer destination of the received data (Step S301). In more detail, the checking unit 340 checks that there is space in the storage unit 32 (transfer buffers 303a to 303f of the main memory 302) via the transfer processing unit 31.

Meanwhile, the GPU-CPU transfer instruction unit 330 of the calculation unit 33 checks whether the received data to be acquired is transferred to and stored in the storage unit 32 (Step S302). As described above, the communication unit 34 and the calculation unit 33 asynchronously check the storage unit 32.

Then, the CPU-NIC transfer instruction unit 310 instructs the communication unit 34 to store the data in a set area of the storage unit 32 (Step S303). Then, the communication unit 34 transfers the received data stored in the transfer buffer 341 to a plurality of areas of the storage unit 32 (Step S304A). Specifically, the received data is burst-transferred to the transfer buffers 303a to 303f of the main memory 302.

Next, when the GPU-CPU transfer instruction unit 330 of the calculation unit 33 checks that there is data transferred to the storage unit 32 in Step S302, the GPU-CPU transfer instruction unit 330 acquires the data from the plurality of areas of the storage unit 32 (Step S305A). Specifically, the GPU-CPU transfer instruction unit 330 starts the acquisition of the received data at the time point at which a fragment of the received data is stored in the plurality of areas of the storage unit 32. The acquisition of the data executed in Step S305A is also performed by burst transfer using a plurality of transfer buffers. The acquired data is stored in the transfer buffer 332 of the calculation unit 33.

Now, data transfer processing using burst transfer of a related-art example is described with reference to FIG. 19 for the sake of comparison with the data transfer processing according to this embodiment.

As illustrated in FIG. 19, a communication unit first receives data from the outside over a communication network (Step S1300). Next, the communication unit checks whether there is space in a predetermined area of a storage unit via a transfer processing unit (Step S1301). When the communication unit checks that there is space in the predetermined area of the storage unit, the communication unit receives a transfer instruction from the transfer processing unit (Step S1302).

Next, the communication unit checks that a storage unit included in a calculation unit has an empty area on the basis of an instruction from the transfer processing unit (Step S1303). When the communication unit checks that the calculation unit has an empty area, the communication unit receives a transfer instruction via the transfer processing unit (Step S1304).

Then, the communication unit burst-transfers the received data to the storage unit that is a main memory of the computer from a transfer buffer (Step S1305A). When the burst transfer between the communication unit and the main memory is completed, a computer acquires the received data from the main memory by burst transfer (Step S1305B).

Now, in the data transfer processing according to this embodiment described in FIG. 18, buffer check between the communication unit 34 and the transfer processing unit 31 (storage unit 32) and buffer check between the calculation unit 33 and the transfer processing unit (storage unit 32) are asynchronously performed. The transfer processing of the data is also asynchronously performed, and hence the time T1 necessary for the buffer check and time T2 necessary for the transfer of the data are shorter than the time T′ necessary for the buffer check and time T″ necessary for the data transfer performed in a synchronous manner in the burst transfer of the related-art example described in FIG. 19.

As described above, according to Embodiment 4, the CPU 301 and the GPU 303 asynchronously perform the instruction of data transfer in the computer 30A and burst-transfer data with use of the plurality of transfer buffers 303a to 303f and 305a to 305f, and hence the transfer delay of data in the computer 30A can be decreased.

According to this embodiment, the waiting time for the transmission and reception of data in the NIC 306 is decreased, and hence the processing in the computer 30A can be accelerated.

In this embodiment, the plurality of transfer buffers 303a to 303f and 305a to 305f are used, and hence the transfer throughput in the computer 30A can be improved when the size of the data to be transferred is relatively large. In particular, this embodiment is effective for a case where the operation result for each layer of the neural network is transferred as that described in Embodiment 1.

In this embodiment, the transfer delay of each computer can be decreased, and hence the processing of the distributed deep learning system formed by the plurality of computers can be performed at a higher speed.

### Embodiment 5

Next, Embodiment 5 of the present invention is described. In the description below, the same configurations as those of Embodiment 1 to Embodiment 4 described above are denoted by the same reference characters, and descriptions thereof are omitted.

In Embodiment 1 to Embodiment 4, a case where the size of the transfer buffer is fixed is supposed. Meanwhile, in Embodiment 5, a configuration in which the buffer size of the transfer buffer is variable in accordance with the transferred data size is employed.

Hitherto, the buffer size of the transfer buffer and the like has been fixed and has not been dynamically changed in accordance with the transferred data. However, when the size of the buffer is too large for the transferred data, there are problems in that a delay in data transfer time is caused, the occupied memory area increases, and the execution time when the memory is searched after the transfer increases, for example.

Meanwhile, when the size of the buffer is too small for the transferred data, the data transfer needs to be repeated many times, and a delay in the data transfer time is caused.

In this embodiment, the size of a transfer buffer used in each computer forming a distributed deep learning system is dynamically changed in accordance with the transferred data size. For example, the buffer size of the transfer buffer is variable so as to be a buffer size in accordance with the data size of the result of backpropagation calculation of a neural network.

As another example, as described in Embodiment 1, when data is transferred by processing the result of the backpropagation calculation by each computer for each element and each row of a matrix, the transferred data size is prespecified. In a case as above, the size of the transfer buffer can be preset in accordance with the data size.

As described above, according to Embodiment 5, the buffer size of the transfer buffer is optimized in accordance with the transferred data size, and hence a delay in the transfer time of data in the computer can be decreased.

By optimizing the buffer size, the occupied memory area in a storage unit can be decreased. As a result, the time necessary for the memory search when the order of transfer of the data stored in the storage unit is changed can be decreased.

The transfer buffer of which the buffer size is optimized is used in each of the computers forming the distributed deep learning system, and hence distributed deep learning can be performed at a higher speed.

The distributed deep learning system and the data transfer method of embodiments of the present invention have been described above, but the present invention is not limited to the described embodiments, and various modifications that could be conceived by a person skilled in the art can be made within the scope of the invention described in the claims.

### REFERENCE SIGNS LIST

1, 1-0 to 1-2 Computer
2 Allreduce processing apparatus
10 Learning data input unit
11 Forward propagation calculation unit
12 Back propagation calculation unit
13 Transfer processing unit
14, 110, 120 Storage unit
15 Communication unit
111, 121, 150, 105, 107 Transfer buffer
101 CPU
102 Main memory
103 GPU
104 Memory
106 NIC

1.-8. (canceled)

9. A distributed deep learning system, comprising:
a plurality of computers connected to each other over a communication network, each computer configured to iteratively perform forward propagation calculation and backpropagation calculation based on learning data and further configured to send a calculation result of the backpropagation calculation to the communication network; and
a group communicator connected to the plurality of computers over the communication network, the group communicator configured to process calculation results of backpropagation calculations received from the plurality of computers and to return the calculation results to transmission sources;
wherein each of the computers include:
a calculator including:
a forward propagation calculator configured to perform the forward propagation calculation for each of a plurality of layers; and
a backpropagation calculator configured to calculate a partial derivative of a configuration parameter of a neural network with respect to an error between a calculation result of the forward propagation calculation and a set label data for each of the plurality of layers in an order of an output layer, a middle layer, and an input layer of the neural network;
a transfer processor configured to store the calculation result of the backpropagation calculation in a transfer buffer each time the backpropagation calculator calculates the calculation result of the backpropagation calculation for each of the plurality of layers; and
a communicator configured to sequentially transmit the calculation results of the backpropagation calculation stored in the transfer buffer to the group communicator over the communication network; and
wherein the group communicator is configured to process the calculation results of the backpropagation calculation in an order of reception from the plurality of computers and sequentially output the calculation results.

10. The distributed deep learning system according to claim 9, wherein:
the communicator is configured to receive the calculation result of the backpropagation calculation for each of the plurality of layers that is processed and returned by the group communicator over the communication network; and
the forward propagation calculator is configured to use the calculation result of the backpropagation calculation for each of the plurality of layers that is processed and returned by the group communicator as input data.

11. The distributed deep learning system according to claim 10, further comprising an adjuster configured to perform adjustment such that the calculation results of the backpropagation calculation for the plurality of layers that are processed and returned by the group communicator and included in the input data input to the forward propagation calculator are in the order of the input layer, the middle layer, and the output layer in each of the plurality of computers.

12. The distributed deep learning system according to claim 9, wherein the transfer buffer is configured to have a buffer size that is variable in accordance with a size of data to be stored therein.

13. A distributed deep learning system, comprising:
at least one computer connected to a communication network, wherein the computer includes:
a communicator configured to receive data from outside over the communication network;
a first transfer instructor configured to give an instruction for transferring the data received by the communicator;
a storage configured to store the data received by the communicator in a transfer buffer based on the instruction of the first transfer instructor;
a second transfer instructor configured to give an instruction for transferring the data stored in the transfer buffer; and
a calculator configured to perform an operation of a neural network using the data;
wherein the first transfer instructor and the second transfer instructor are configured to asynchronously give instructions; and
wherein the second transfer instructor is configured to give an instruction for transferring the data to the calculator.

14. The distributed deep learning system according to claim 13, wherein:
the second transfer instructor is configured to give an instruction for transferring an operation result obtained by the calculator to the transfer buffer;
the first transfer instructor is configured to give an instruction for transferring the operation result to the communicator from the transfer buffer; and
the communicator is configured to transmit the operation result transferred based on the instruction from the first transfer instructor to the outside over the communication network.

15. The distributed deep learning system according to claim 14, wherein the storage includes a plurality of transfer buffers.

16. The distributed deep learning system according to claim 13, wherein the transfer buffer is configured to have a buffer size that is variable in accordance with a size of data to be stored therein.

17. A data transfer method of a distributed deep learning system, the system comprising a plurality of computers connected to each other over a communication network, each computer iteratively performing forward propagation calculation and backpropagation calculation based on learning data and sending a calculation result of the backpropagation calculation to the communication network, and a group communicator connected to the plurality of computers over the communication network, wherein the group communicator processes calculation results of backpropagation calculations received from the plurality of computers and returns the calculation results to transmission sources, the data transfer method comprising:
a first step of performing the forward propagation calculation for each of an input layer, a middle layer, and an output layer of a neural network for each of a plurality of layers based on input data including the learning data in each of the plurality of computers;
a second step of calculating a partial derivative of a configuration parameter of the neural network with respect to an error between a calculation result of the forward propagation calculation and a set label data for each of the plurality of layers in an order of the output layer, the middle layer, and the input layer in each of the plurality of computers;
a third step of storing the calculation result of the backpropagation calculation to a transfer buffer each time the calculation result of the backpropagation calculation is calculated for each of the plurality of layers in the second step in each of the plurality of computers;
a fourth step of sequentially transmitting the calculation results of the backpropagation calculation stored in the transfer buffer to the group communicator over the communication network in each of the plurality of computers; and
a fifth step of processing the calculation results of the backpropagation calculation received by the group communicator in an order of reception from the plurality of computers and sequentially outputting the calculation results.
